(19) United States
(12) Patent Application Publication
(10) Pub. No.: US 2005/0097452 A1
(43) Pub. Date: May 5, 2005

(54) Conversion program from SGML and XML to XHTML

(76) Inventor: George N. Eross, Nashua, NH (US)

Correspondence Address: Edward A. Pennington, Esq.;Swidler Berlin Shereff Friedman, LLP, Suite 300, 3000 K Street, N.W., Washington, DC, 20007-5116, US

(21) Appl. No.: 10/698,487

(22) Filed: Nov. 3, 2003

(51) Int. Cl. G06F 15/00

(52) U.S. Cl. 715/513

(57) ABSTRACT

A structured document is converted independent of the application that created the structured document. A structured document, such as SGML and XML, is parsed to convert the structured document on an element by element basis. For each element identified control is passed to an element handler established for that identified element. Each element handler performs the function of parsing the element for which it was established and generates a corresponding XHTML content fragment.

### BACKGROUND OF THE INVENTION

1. Field of the Invention

The present invention relates to a method, a system and computer program product for converting structured documents. More particularly, the present invention relates to a method, a system and a computer program product for conversion of EXtensible Markup Language (“XML”) and Standard Generalized Markup Language (“SGML”) structured documents to EXtensible Hypertext Markup Language (“XHTML”) on an element by element basis.

2. Description of the Prior Art

Generally, the conversion of structured documents, such as SGML and XML, produced by a particular application to HTML content requires the use of a particular third party software. Typically, a particular third party tool is required to convert a structured document to HTML content because it is designed to rely on the format that the particular application stores the structured documents in order to generate HTML content corresponding to the structured document. In most cases, the third party software must be licensed. Licensing of third party software can come at an appreciable cost to a company.

Once this third party software is licensed it must be properly installed. The installation of third party software can be a relatively complex procedure. This is due, in part, to the fact that the third party software is usually not initially configured to operate with a company's proprietary/legacy system and software applications. As a result, a considerable amount of time and money can be spent re-configuring the third party software so that it can operate cohesively with the company's legacy system and software applications.

The re-configuring of third party software is a highly technical process. The technical process must be performed by individuals with specific technical competence. Accordingly, companies and organizations must maintain a staff of highly skilled engineers or outsource these tasks.

There is a need for a new method of converting structured documents, such as SGML and XML, to HTML content. There is a further need for a new method for converting structured documents that operates independent of the application that created the structured document. There is also a need for a method for converting structured documents that can be easily integrated with an existing system. There is also a need for a method of converting structured documents that requires less use of company resources. There is a need for a computer program product for converting structured documents, such as SGML and XML, to HTML content. There is a need for a framework for converting structured documents, such as SGML and XML, to HTML content.

### SUMMARY OF THE INVENTION

According to embodiments of the present invention, a method, a framework and a computer program product for converting a structured document, such as SGML and XML, to HTML content are provided. The method converts a structured document independent of the application that created the structured document. The method parses a structured document, such as SGML and XML, to convert the structured document on an element by element basis. For each element identified control is passed to an element handler established for that identified element. Each element handler performs the function of parsing the element for which it was established and generates a corresponding XHTML content fragment.

The format of an XHTML content fragment is defined by information in a set up file in combination with program instructions or a user controlled style sheet. The method performs conversion of a structured document, such as SGML and XML, independent of the application program that created the structured document. The method can provide XHTML content with features that adhere to, and comply with, government and industry published accessibility standards. The method can automatically generate title and summary information for tables, descriptive text for figures, identification and header information for table data cells, and information that aid visually impaired users to navigate through tables.

In an embodiment of the present invention, the method of converting a structured document, such as SGML and XML, to HTML content includes traversing a structured document. It is determined whether a set of first level elements are contained within the structured document. A first level XHTML content fragment is generated corresponding to each element in the set of first level elements. Each of the first level XHTML fragments is stored. The first level XHTML fragments are generated independent of the application that created the structured document.

The method can further include parsing each element in the set of first level elements and determining whether each element in the set of first level elements contains a set of second level elements A second level XHTML content fragment can be generated corresponding to each element in the set of second level elements. The method can include storing each of the second level XHTML fragments. Parsing can be accommodated for elements nesting to any depth or level.

The method can further include determining the document type for the structured document. The document type can include books and standalones. The document type is determined when the structured document is opened. The method can further include generating a linked list of cross-references including each element in the set of first level element having a cross-reference identification.

According to an embodiment of the present invention, a computer program product for converting a structured document, such as SGML and XML, to HTML content includes a computer readable medium and computer program instructions, recorded on the computer readable medium, executable by a processor. The computer program instructions perform the steps of traversing a structured document, and determining whether a set of first level elements are contained within the structured document. The computer program instructions perform the steps of generating a first level XHTML content fragment corresponding to each element in the set of first level elements and storing each of the first level XHTML fragments. The first level XHTML fragments are generated independent of the application that created the structured document.

The computer program product can further include computer program instructions that perform the steps of parsing each element in the set of first level elements and determining whether each element in the set of first level elements contains a set of second level elements. The computer program instructions can perform the steps of generating a second level XHTML content fragment corresponding to each element in the set of second level elements and storing each of the second level XHTML fragments. Parsing can be accommodated for elements nesting to any depth or level.

The computer program product can further include computer program instructions for performing the steps of determining the document type for the structured document. The document type can include books and standalones. The document type is determined when the structured document is opened. The computer program product can further include computer program instructions for performing the steps of generating a linked list of cross references including each element in the set of first level element having a cross reference identification.

### BRIEF DESCRIPTION OF THE DRAWINGS

The above described features and advantages of the present invention will be more fully appreciated with reference to the detailed description and appended figures in which:

FIG. 1 depicts an exemplary functional block diagram of a framework in which the present invention can find application; and

FIG. 2 depicts an exemplary flow diagram for a method of converting structured documents to HTML content according to an embodiment of the present invention.

### DETAILED DESCRIPTION OF THE INVENTION

The present invention is now described more fully hereinafter with reference to the accompanying drawings that show embodiments of the present invention. The present invention, however, may be embodied in many different forms and should not be construed as limited to embodiments set forth herein. Appropriately, these embodiments are provided so that this disclosure will be thorough and complete, and will fully convey the scope of the present invention.

According to embodiments of the present invention, a method, a framework and a computer program product for converting a structured document, such as SGML and XML, to HTML content are provided. The method converts a structured document independent of the application that created the structured document. The method parses a structured document, such as SGML and XML, to convert the structured document on an element by element basis. For each element identified control is passed to an element handler established for that identified element. Each element handler performs the function of parsing the element for which it was established and generates a corresponding XHTML content fragment.

The format of an XHTML content fragment is defined by information in a set up file in combination with program instructions or a user controlled style sheet. The method performs conversion of a structured document, such as SGML and XML, independent of the application program that created the structured document. The method can provide XHTML content with features that adhere to, and comply with, government and industry published accessibility standards. The method can automatically generate title and summary information for tables, descriptive text for figures, identification and header information for table data cells, and information that aid visually impaired users to navigate through tables.

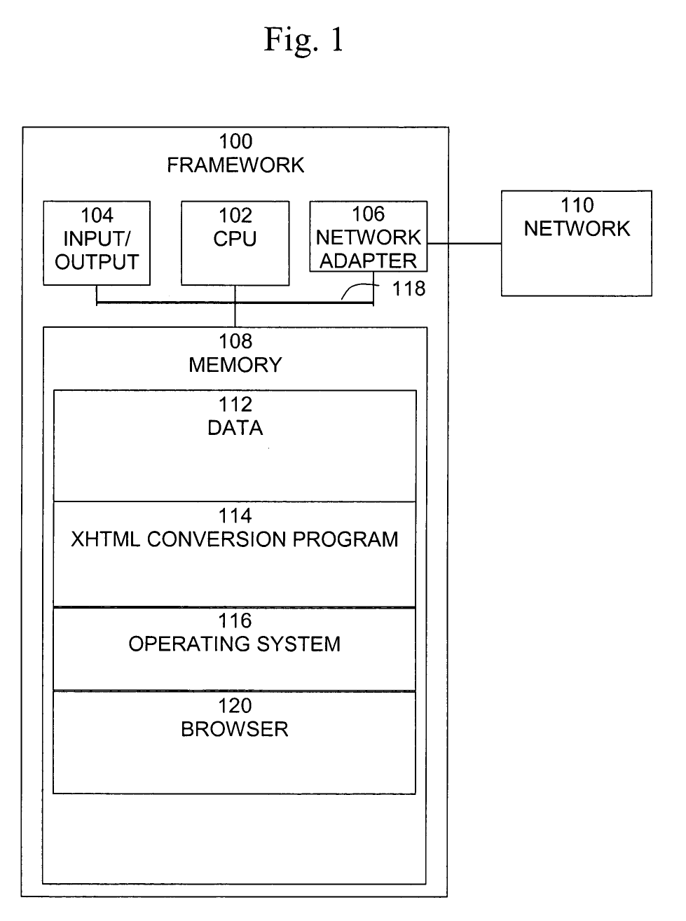

FIG. 1 depicts a functional block diagram of a Framework in which the present invention can find application. In the embodiment of FIG. 1, Framework 100 can be implemented to convert a structured document, such as SGML and XML, to HTML content, such as XHTLM. In the FIG. 1 embodiment, Framework 100 is a general-purpose computer, such as a workstation, personal computer, server or the like, but can be any apparatus that executes program instruction in accordance with the present invention. Framework 100 includes a processor (CPU) 102 connected by a bus 118 to memory 108, network interface 110 and I/O circuitry 104.

In the FIG. 1 embodiment, the CPU 102 is a microprocessor, such as an INTEL PENTIUM® or AMD® processor, but can be any processor that executes program instructions in order to carry out the functions of the present invention. As shown, the CPU 102 and the various other components of the Framework 100 communicate through a system bus 118 or similar architecture. The network interface 110 provides an interface between the Framework 100 and a network (not shown), such as the Internet. The network (not shown) can be a local area network (LAN), a wide area network (WAN), or combinations thereof. The I/O circuitry 104 provides an interface for the input of structured information to and output of structured information. The I/O circuitry 104 includes input devices, such as trackball, mice, touchpads and keyboards, and output devices, such as printers and monitors.

In the FIG. 1 embodiment, the memory 108 stores XHTML conversion program 114, data 112, and operating system 116, such as a Microsoft Window® or UNIX® operating system, but can be any operating system that provides overall system functionality in accordance with the present invention. The data 112 can be any structured document, such as a XML file and a SGML file. The memory 108 can also include a browser 120 for providing HTML content to the I/O circuitry 104.

In the FIG. 1 embodiment, the XHTML conversion program 114 provides the functionality associated with converting a structured document, such as SGML and XML, to HTML content as executed by the CPU 102. The XHTML conversion program 114 is designed to produce XHTML web content that adheres to documentation standards, such as Oracle® Documentation Standards. These standards are encapsulated in the Oracle® Style Guide, which is based on, and supplements, accepted and established authorities on English grammar, style, spelling and use. These authorities include, but are not limited to, the Harbrace College Handbook®, Revised Twelfth Edition, the Merriam-Webster's Collegiate Dictionary®, Tenth Edition, the Chicago Manual of Style®, Fourteenth Edition, and the Elements of Style®, Third Edition.

The XHTML conversion program 114 can be designed to facilitate adherence to, and compliance with, government and industry published Accessibility Standards. In accordance with these standards, the XHTML conversion program 114 can provide automated table cell identification tags that aid visually impaired users in navigating through table data. The XHTML conversion program 114 can include a suite of graphical images, such as icons, that can be provided with HTML content. These graphical images are copied from a source file to an output destination directory.

In the FIG. 1 embodiment, the methods of the XHTML conversion program 114 parses structured documents, such as SGML and XML documents, on an element by element basis. The type of structured documents can include, but are not limited to, books and standalones. For each element identified by XHTML conversion program 114 control is passed to an element handler established for that element. Element handlers can also identify other elements within an element and pass control to an element handler established for the element identified within the element. Each element handler performs the function of parsing the respective element and generating a XHTML content fragment corresponding to the element. XHTML content fragments are stored as an output file.

The Element handlers provided by XHTML conversion program 114 can include a Table of Contents handler, a Title and Copyright Page handler, a Reader's Comment Form handler, a Preface(s) handler, a Chapters handler, Sections handler, a Part Pages handler, an Appendices handler, a Glossary handler, and an Index handler. The Table of Contents handler lists the contents of the book and contains navigation mechanisms to all of the book components. Book components include, but are not limited to, Lists of Examples, such as Figures and Tables, Title and Copyright Page, Reader's Comment Form; Preface(s), Chapters, Chapter Sections, Part Pages Appendix(s), Glossary, and Index.

The List of Examples contains a summary of all of the examples in the book and provides the reader with navigation mechanisms to quickly access any specific example through a hyperlink. The List of Figures contains a summary of all of the figures in the book and provides the reader with navigation mechanisms to quickly access any figure through a hyperlink. The Lists of Tables contains a summary of all of the tables in the book and provides the reader with navigation mechanisms to quickly access any table through a hyperlink.

The Title and Copyright page contains the Product Name, Book Title, Volume Number, Release Number, Platform, and Part Number. Additionally it contains the mandatory legal notices and disclaimers. Optionally, it can also contain Contributing Author credits. The Reader's Comment Form gives the reader an opportunity to provide comments and suggestions on the quality and usefulness of the book. The Preface provides information about the book itself including the intended audience, the book structure, other related documents, and information pertaining to the conventions related to the book. The Part Pages divide the book into identified parts that introduce the contents of each part and provide a list of the chapters contained therein. The Chapters form the body of the book. Each chapter should have an introduction that describes what the chapter covers and can include a list of sections in that chapter. The Appendixes provide additional information that is helpful, though not essential, to the reader's understanding of the material covered by the book. The Glossary provides a list of product terms and their definitions. The Index provides an alternate way for readers to find information and contains hyper links to specific sections to the book that reference the terms contained therein.

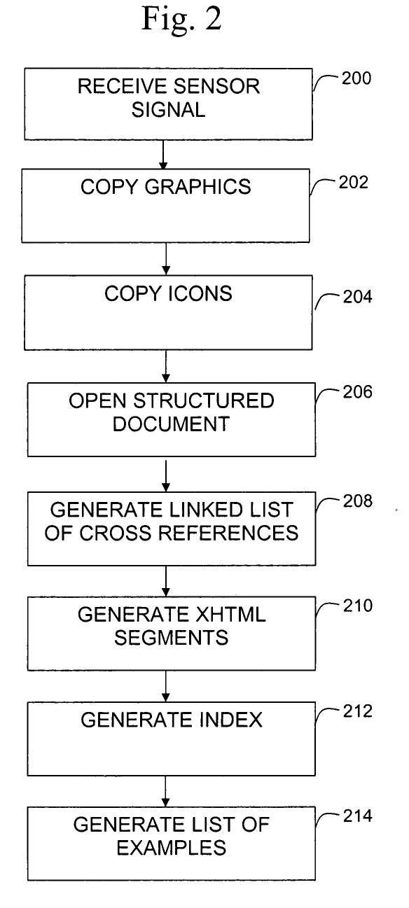

An exemplary flow diagram of an embodiment for converting structured documents to HTML content is shown in FIG. 2. FIG. 2 is best understood when read in combination with FIG. 1. As shown in FIG. 2, the process begins with step 200, in which XHTML conversion program 114 initializes. Initialization includes, but is not limited to, setting of Framework's 100 internal structures and start up files, building input and output directories, and creating output directories. In step 202, graphics are copied from the input directory to the output directory of Framework 100. The graphics copied from the input directory are figures supplied by, and referenced in, the body of the structured document. In step 204, support files and icons are copied from the installation directory to the output directory of the Framework 100. The icons can be placed on generated HTML content. The icons in the installation directory are supplied by us as part of the distribution kit and can include, but is not limited to,company logos, and navigation icons.

In step 206, the structured document, such as a XML or a SGML file, is opened to determine its document type. The file can be opened by providing the file name to XHTML conversion program 114. The document types include, but is not limited to, books and standalones. Structured documents of the book document type include a plurality of segments. These segments are provided in a “parent” SGML or XML file as separate files. The “parent” SGML or XML file also provides the names of the other components, chapter, appendices, etc., as well as the order in which they are assembled, the names of the figures that are referenced in the document, the definitions of the variables that may be referenced, and the status of conditional sections including whether they are shown or hidden). Each separate file includes, but is not limited to, the text of paragraphs, references to figures and variables. Structured documents of the standalone type includes the text of paragraphs, references to figures, variables, controlling information of the definitions of variables, and file names corresponding to figures of this information in a single file. The document type of a structured document is determined by identifying a document type encrypted within a file selected for conversion.

In step 208, a linked list of cross-references for the opened structured document file is generated. The XHTML conversion program 114 builds a linked list of cross-references. Cross references are hotspots that will be included in HTML content to allow direct navigation to a section of the HTML content designated by the hotspot. The XHTML conversion program 114 builds a linked list by stepping through a structured document file and identifying all elements within the structured document file. Each element identified is checked to determine whether the element has a cross-reference identification. If an element is determined to have a cross-reference identification, it is designated as a cross-reference target and placed on the linked list for the structured document. The structured document file is reset to the beginning of the file when the end of the file is reached.

In step 210, conversion of the opened structured document file to HTML content is performed. The XHTML conversion program 114 generates a XHTML content fragments. XHTML content fragments correspond to elements within structured documents, such as XML and SGML. The XHTML conversion program 114 generates XHTML content fragments by stepping through the reset structured document file and identifying all elements with the structured document file. For each element identified by conversion program 114 control is passed to an element handler defined for that element. Element handlers can also identify other elements within an element and pass control to an element handler defined for the element identified within the element. Each element handler performs the function of parsing the respective element and generating a corresponding XHTML content fragments Each element handler performs a standard set of operations including, but not limited to, :retrieving any attributes that it may contain; performing actions based on attribute settings specific to itself employing a utility function. This function in turn calls lower level functions to interpret any entities (variables) that may be referenced. The function vectors to other element handlers if it encounters an embedded, lower level, element. The function calls other functions (handlers) upon encountering index hits, cross-references, etc. Once the processing for a specific element is concluded, The function returns control to the main scanning routine, which continues searching the file for the next element. Upon finding another element, it calls the appropriate handler and the sequence repeats itself.

In step 212, an index is generated. Markers are provided within the structured document An anchor is generated at the spot in the XHTML corresponding to the spot in the source document where the markers are placed. An index entry is created, using the information referencing this anchor. During the course of the document conversion processing, the index entries are maintained in a linked, sorted list in memory. Once the document processing has concluded, the linked list of sorted entries is written to a file.

In step 214, a list of examples are generated. The list of examples is generated as a consequence of the presence in the document of a formal element that are examples containing a Title. Upon encountering a formal element, an anchor is placed in the XHTML as a landing site and an entry, with a generated sequence number (e.g. FIG. 3-11), is created in the output file which will become the list of examples (or figures, or tables).

While specific embodiments of the present invention have been illustrated and described, it will be understood by those having ordinary skill in the art that changes can be made to those embodiments without departing from the spirit and scope of the invention.

1. A method of converting a structured document to XHTML content, the method comprising the steps of:
traversing a structured document;
determining a set of first level elements contained within the structured document;
generating a first level XHTML content fragment corresponding to each element in the set of first level elements; and
storing each of the first level XHTML fragments;
wherein the first level XHTML fragments are generated independent of the application that created the structured document.

2. The method according to claim 1, further comprising parsing each element in the set of first level elements.

3. The method according to claim 2, further comprising determining whether each element in the set of first level elements contains a set of second level elements.

4. The method according to claim 3, further comprising generating a second level XHTML content fragment corresponding to each element in the set of second level elements.

5. The method according to claim 4, further comprising storing each of the second level XHTML fragments.

6. The method according to claim 1, further comprising determining the document type for the structured document.

7. The method according to claim 6, wherein the document type includes one of: a book and standalone.

8. The method according to claim 1, further comprising opening the structured document.

9. The method according to claim 1, further comprising generating a linked list of cross references including each element in the set of first level element having a cross reference identification.

10. A computer program product for converting a structured document to XHTML content, the computer program product comprising the steps of:
a computer readable medium; and
computer program instructions, recorded on the computer readable medium, executable by a processor, for performing the steps of:
traversing a structured document;
determining a set of first level elements contained within the structured document;
generating a first level XHTML content fragment corresponding to each element in the set of first level elements; and
storing each of the first level XHTML fragments;
wherein the first level XHTML fragments are generated independent of the application that created the structured document.

11. The computer program product according to claim 10, further comprising computer program instructions for parsing each element in the set of first level elements.

12. The computer program product according to claim 11, further comprising computer program instructions for determining whether each element in the set of first level elements contains a set of second level elements.

13. The computer program product according to claim 12, further comprising computer program instructions for generating a second level XHTML content fragment corresponding to each element in the set of second level elements.

14. The computer program product according to claim 13, further comprising computer program instructions for storing each of the second level XHTML fragments.

15. The computer program product according to claim 10, further comprising computer program instructions for determining the document type for the structured document.

16. The computer program product according to claim 15, wherein the document type includes one of: a book and standalone.

17. The computer program product according to claim 10, further comprising computer program instructions for opening the structured document.

18. The computer program product according to claim 10, further comprising computer program instructions for generating a linked list of cross references including each element in the set of first level element having a cross reference identification.
